(19) United States
(12) Patent Application Publication
(10) Pub. No.: US 2022/0094702 A1
(43) Pub. Date: Mar. 24, 2022

(54) System and Method for Social Engineering Cyber Security Training

(71) Applicant: UNIVERSITY OF WINDSOR, Windsor (CA)

(72) Inventors: Sherif SAAD AHMED, Windsor (CA); Luis Gabriel Rueda, Windsor (CA)

(73) Assignee: UNIVERSITY OF WINDSOR

(21) Appl. No.: 17/476,610

(22) Filed: Sep. 16, 2021

Related U.S. Application Data
(60) Provisional application No. 63/082,659, filed on Sep. 24, 2020.

(51) Int. Cl. H04L 29/06; G06N 20/00

(52) U.S. Cl. CPC H04L 63/1416; H04L 63/20; G06N 20/00

(57) ABSTRACT

A system and method are provided for growing cyber security awareness relating to social engineering and administering anti-social engineering training. The system makes use of artificial intelligence (AI), cyber security strategies and/or gamification principles to help organizations better understand and prepare for potential social engineering security risks. One embodiment of the system includes a reinforcement learning (RL) module, which further includes a trained predictor and an agent that interacts with a target. The RL module receives as input a training dataset that includes information about the target. The trained predictor generates a bait for the target based on the input training dataset; and the agent delivers the generated bait as an attack on the target. The RL module outputs a playbook of the attack, which can be used to update the training dataset and the trained predictor for subsequent iterative attacks, and/or to recommend social engineering countermeasures to the target.

### RELATED APPLICATIONS

This application claims priority and the benefit of 35 USC § 119(e) to U.S. provisional patent application No. 63/082,659, filed 24 Sep. 2020, the entirety of which is incorporated herein by reference.

### SCOPE OF THE INVENTION

The present invention generally relates to a method and system for cyber security training, and in particular, to methods and systems which incorporate artificial intelligence (AI) to assist in providing reinforcement, training and education to provide users with enhanced, updated and/or real time awareness of cyber security threats, including those which are social engineering based.

### BACKGROUND OF THE INVENTION

One of the greatest threats to cyber security in recent years has been human error. Even the most reliable and secure cyber security plan can be foiled through simple human error, coupled with a lack of appropriate cyber security awareness and cyber threat training.

Computer hackers today commonly use social engineering methods, such as phishing, pharming, baiting, vishing, smishing and other data collection schemes, to trick their victims into committing security mistakes and/or disclosing passwords and other sensitive or secure targeted information. Frequently cyber attacks appear in the form of e-mails, text messages and other electronic communications which are cloaked so as to appear as legitimate correspondence, and which bait the recipient into providing a response with targeted information. On harvesting any disclosed information, the victim and/or his or her employer may thereafter be vulnerable not only to further cyber attacks such as ransom ware or other malware, but also client and/or corporate data theft.

The most secure firewalls, encryptions and even access devices may all be circumvented if the individual person that manages them, or who enjoys their free access, falls victim to a social engineering phishing on the cyber attack scheme. Hackers may, for example, use cleverly crafted e-mails (phishing), voice calls (vishing), cloaked malware downloads or SMS messages (smishing) and other such electronic communication to target individuals, in order to deceive, manipulate and elicit from them key confidential information (e.g. usernames, passwords, and other credentials). Different types of social engineering methods used in cyber attacks are identified more fully in Salandine, F., Kaabouch, N., “Social Engineering Attacks: A Survey”, Future Internet, published Apr. 2, 2019, the entirety of which is incorporated herein by reference. User information which is mistakenly disclosed in response to a cyber attack thereafter may be used in the illicit bypassing of computer and/or database software, firewalls, password protected databases and file records, antivirus software and/or other security systems. In this way, one may conclude that one of the weakest links in cybersecurity today remains the individual people who use, administer, operate and account for the computer systems containing protected information.

The most effective way to prevent cyber security breaches involving cyber attacks which utilize social engineering scheme is to teach people who use and manage key computer systems how to recognize, and thus avoid, socially engineered cyber attacks. An education program that instils awareness of the types of social engineering schemes adopted and a broad understanding of cyber security, information technology (IT) best practices and even regulatory compliance, can be a great help in reducing the number of cyber security breaches that occur through a lack of security awareness. Such education curriculums are commonly referred to as Security Education, Training and Awareness (SETA) programs.

Currently, most SETA programs are administered through hands-on workshops, online lecture courses and other traditional course-based training methods. These platforms can often be slow, unengaging and ultimately ineffective. There is thus a need in the art for an improved SETA tool that provides a more engaging, customizable, productive, and preferably ongoing security awareness and training experience to users.

### SUMMARY OF THE INVENTION

To at least partially overcome some of the inherent problems and limitations of conventional SETA programs existing, the inventors have developed a new multilayer technological tool for use in providing users with reinforced cyber security awareness relating to social engineering-based cyber attacks. In in a preferred embodiment a SETA tool is provided which may be used in administering anti- or counter-social engineering cyber attack training.

In one possible embodiment, the tool includes a host computer which includes a hardware processor and computer readable storage medium for storing program code or subroutines, and which preferably is adapted to electronically communicate with one or more remotely disposed customer or target user computers, personal digital assistants (PDAs), tablets, cellphones or other workstations (hereinafter collectively “workstations”). Most preferably the program code, when executed operates to provide a multilayer technology which makes use of preselected stored data files, scripts or playbooks and artificial intelligence (AI) to generate and execute simulated cyber security strategies. Optionally, the SETA tool may incorporate or operate with gamification principles which provides reinforcement and/or penalties in order to help users and organizations understand, recognize and better prepare for potential security risks associated with social engineering based cyber threats.

In another non-limiting embodiment, the multilayer technology tool may take the form of a system which includes a hardware processor which is adapted to electronically communicate simultaneously with one or more workstations of a target user, organization or department, and effect an iterative, cyber threat awareness training method.

Although not essential, in one possible mode the particular trainee target user, learner, organization or department (hereafter collectively the “target user”) is initially assessed to identify potential social engineering and/or other cyber security threat vulnerabilities. The initial target user assessment may be undertaken manually, but most preferably is affected remotely by automated data harvesting of background data about the target user by means of smart bots, or other AI methodologies so as to identify specific customer and/or user profile data to better simulate real world cyber attack strategies. Non-limiting examples of potential sources of profile data which may be used to identify security threat vulnerabilities could include without limitation, personal information of the target user, customer key employee information, including martial or family status, professional or social memberships and contacts, general biographical information, public and searchable corporate information related to business plans, as well as information related to customer or user computerized and technical systems, corporate service providers and customer information.

Whilst Al programs allow for the efficient automated harvesting of background user data in a manner simulating real-world events, in another possible mode, such data may be supplied and collected with the cooperation with the target user and/or his or her employer, where for example, the SETA tool is to be run as part of a blind test.

Following initial target user data harvesting and collection, the relevant security vulnerabilities are then extracted from harvested data through aggregation and correlation methods. In one non-limiting mode relevant security vulnerabilities may be identified and assessed by classifying and/or comparing the initial and/or collected profile data for potential matches with criteria used in a number of possible pre-identified cyber attack strategies stored in the remote processor memory. Preferably, pre-identified cyber attack schemes or playbooks are selected with a view to identify the most likely cyber attack strategies (i.e. phishing, cloaked malware downloads etc.) to receive user response. Optionally, the target user's digital footprint on public sources (e.g., world wide web, social/professional/research networks, media, e-mail databases, newsfeeds, public forums, etc.) may also be measured and used with general customer profile data in the collection of background data and/or to provide additional weighting for the estimation of the most likely successful potential threats.

Once the background user data has been compiled, the potential for possible social engineering based cyber threats is estimated. Preferably, AI techniques that make use of machine learning and reinforcement learning are used to analyze possible threat data and craft a most-likely to succeed simulated cyber attack scenario(s) or plan(s). Typically, the attack plan is prepared as a user targeted e-mail, text, or other electronic communication, and which has embedded therein one more target user selected baited protocols which are selected having regard to the background profile data collected, so as to be most likely to illicit a response by the target user containing sensitive or secure information on the misapprehension that the cyber attack communication is either legitimately received or otherwise harmless.

The simulated attack plan(s) is executed by means of a suitable attack engine whereby the baited protocol is electronically forwarded to the target user's workstation soliciting a level of response provided to the target user. The simulated attack plan is preferably selected to gather target user responses and provide electronic feedback to the host computer which tracks and records the target user's level of interaction and/or response. The engineered simulated attack is most preferably carried out as a type of inoculation plan designed specifically for the particular target user. It is recognized that the simulated attack plan(s) carried out by the attack engine are un-weaponized, in that they are not harmful and lack any malicious software or links, typically featured in real-life social engineered attacks. The simulated attack plan(s) preferably, however, is selected to affect data harvesting and storage of the target users' responses, and preferred level of engagement, for subsequent analysis.

The results of the data collected by simulated attack plan(s) are thereafter gathered and analyzed in order to verify the initial estimation of the target user's potential susceptibility to social engineering threats. Once the user's susceptibility potential for social engineering threats has been assessed, one or more subsequent simulated cyber attack may be designed and carried out in an iterative loop using the one or more schemes of reinforcement learning. This iterative loop may continue periodically on a timed basis indefinitely, or until such time as the target user or customer organization meets a threshold level of performance and/or elects to discontinue its SETA program.

The results of one or a number of the simulated cyber attack instances carried out by the attack engine are preferably analyzed and used to create and/or output recommendations to the target user via a reinforcement learning scheme, suitable social engineering-based cyber attack countermeasures. These countermeasures may include without restriction one or more of reinforcement learning schemes, including but not limited to Q-learning, policy-based learning or model-free reinforcement learning implemented in the form of software fixes, firewall implementation, targeted programming, correspondence technique training, system re-configurations, and/or security policies, specific to the target user and/or customer. From these recommendations, the target user and/or his/her organization may thus implement a social engineering firewall (SEF) security strategy in order to reduce and mitigate risks of the discovered social engineering threats.

It has been appreciated that engaging individuals in training programs can be challenging. For this reason, and in addition to reinforcement learning schemes, embodiments of systems may also make use of gamification theory, in order to inject a level of entertainment into the training experience, and provide a more practical and transparent SETA program. In a preferred embodiment, one or more simulated cyber attacks may be generated and/or provided as a part of an overall training module which provides one or more target users with visual cues and/or virtual credits or rewards that may include penalties to reinforce desired behaviours and learn from them.

Embodiments of the SETA tool may advantageously assist an individual or organization in mitigating risks relating to social engineering based cyber attacks. Analytics of the system preferably also are provided to output to one or more users, the identification and/or exploitation of successful bait protocols, as well as potential and/or likely areas of user'vulnerabilities that may exist in current cyber security systems or protocols. Other embodiments of the invention may provide a system and/or method which is operable to test how resilient or immune the target individual or organization is to social engineered attack(s). By discovering potential human vulnerabilities early, the target user may be better placed to prepare and guard against real and malicious social engineering attacks that may occur in future.

The described features and advantages of the disclosure may be combined in various manners and embodiments as one skilled in the relevant art will recognize. The disclosure can be practiced without one or more features and advantages described in a particular embodiment.

### BRIEF DESCRIPTION OF THE DRAWINGS

The advantages and features of the present disclosure will become better understood with reference to the following more detailed description taken in conjunction with the accompanying drawings, in which like elements are identified with like symbols, and in which:

FIG. 1 shows schematically, a system for implementing a SETA program as part of cyber security training and education in accordance with a preferred embodiment of the invention;

FIG. 2 illustrates a preferred methodology of providing counter-social engineering cyber threat training, using the system shown in FIG. 1;

FIG. 3 shows a diagram illustrating a gamification methodology of providing user reinforcement using the anti-social engineering training framework according to a preferred embodiment of the invention;

FIG. 4 illustrates schematically an exemplary a phishing e-mail, generated as part of an initial simulated cyber attack in accordance with an exemplary embodiment of the invention; and

FIG. 5 illustrates schematically an alternate phishing e-mail generated as part of a secondary simulated cyber attack in accordance with a preferred methodology.

### DETAILED DESCRIPTION OF THE PREFERRED EMBODIMENTS

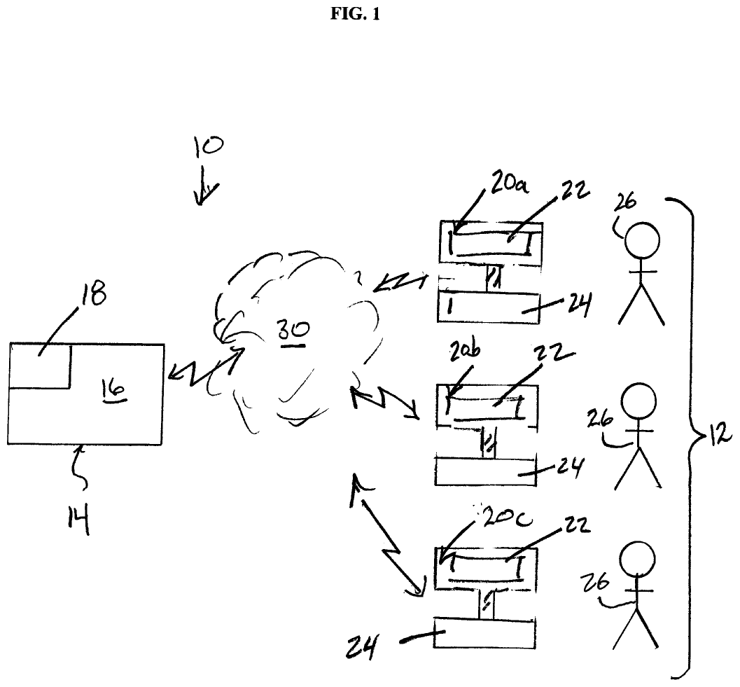

Reference may be had to FIG. 1, which illustrates schematically a system 10 for implementing a SETA program in providing cyber security training at a remote customer worksite 12. The system 10 includes a host computer server 14 which is provided with a processor 16 and memory 18. The host computer server 14 is configured to communicate electronically with a number of individual target user workstations 20a, 20b, 20c at the worksite 12 in a conventional manner, and including without restriction by internet connection with data exchange via cloud computing networks 30.

In the embodiment shown, the individual target user workstations 20a, 20b, 20c are of a conventional computer desktop design, and include a video display 22 and keyboard 24. It is to be appreciated that other workstations could however be provided in the form of tablets, cellular phones, personal digital assistants (PDA's) and the like, and with other suitable manner of communication between the host server 14 and individual workstation 20 being affected.

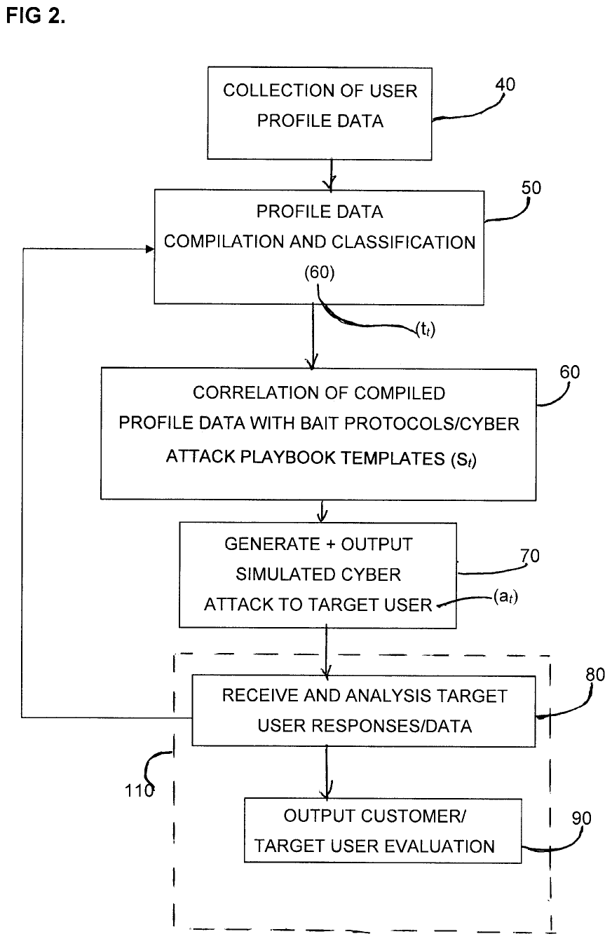

In a preferred training mode, cyber security training is provided to target users 26 who are selected as to the main users of each workstation 20a, 20b, 20c, using the system 10 concurrently. The flowchart shown in FIG. 2 depicts a preferred methodology of implementing the SETA tool using the system 10, and steps of delivering cyber security training to individual target users 26 via workstations 20a, 20b, 20c.

As will be described, preferably cyber training is tailored specifically to each specific target user 26. Whilst typically the target user 26 is generally an individual user of a specific workstation 20a, 20b, 20c, the target user may also be selected as a group of individuals, a department, a section, a role or profile within an organization, or the entire organization itself. Examples of specific potential target users 26 could include for example, a specific individual, the CFO or CEO of a company, the human resources department of a company, financial advisers, and/or any number of people who share a common interest in sport or hobby within an organization. It is a goal of the SETA tool to educate and train the target users 26 in counter-social engineering cyber threat behaviors.

The state sₜ of the SETA teaching algorithm and system profile data file at a particular time may include a feature vector X, which contains information about the target user's profile and other context data. Feature vector or matrix X may be obtained by feeding unstructured data related to the target user 26 (e.g. data in the form of network, graph, text or mixed document, image, etc.) and context data into a representation learning (RPL) algorithm. As will be described, the representation learning algorithm preferably uses any of mapping, graph or document embedding, clustering, data transformation, dimensionality reduction, classification and regression techniques to transform the data.

As will be described, the initial training dataset of profile data depicted in FIG. 2 serves as a first input to a reinforcement learning (RL) algorithm module stored in memory 18, and is used to carry out a sequence of a number of simulated cyber attacks on the target user 26. After the sequence of simulated attacks has been executed, the RL algorithm preferably outputs to the target users 26 a complete playbook and/or scripted of the cyber attack(s), schemes including the target user's 26 response(s).

In the operation of the system 10 in providing user training, as an initial step (40), individual target user and/or client information is initially collected as profile data and compiled to provide for the identification of potential user vulnerabilities to social engineering cyber attacks. Typically, the collection stage 40 includes an information gathering stage in which relevant background data, information regarding a particular target user, context data and/or information relating to the customer organization as a whole (including a number of users) is collected is the initial training data set.

The target user's profile data preferably includes personal information about the individual or group of individuals, as well as information about their status in the organization, role, profession, interactions with other individuals within or outside of the organization, and personal information obtained from social and professional networks, including preferences, amongst others. Examples of profile organization information may furthermore include security policies, type of organization, and environment variables about various internal processes of the organization. Profile data may also include text data. Context data may include proposed cyber attack surface analyses, threat modeling, organization security policies, and other variables of the environment, whether temporal, political, weather, financial or global economy data.

Relevant information may thus include a number of different types of information and/or data that may be useful assessing and identify the potential vulnerabilities to social engineering threats, and which are chosen has having the potential to generate a user response containing with secure and/or sensitive data. Such background information may be collected as information farmed from the target user and/or client's social media profiles, public information related to target user/client technologies and/or service providers public security policies and corporate objectives. As well, personal information of the target of the target user may be gathered including family and friend profiles social memberships, and personal interests.

The information gathering stage 40 depicted in FIG. 2 is most preferably accomplished by means of specially programmed smart bots and/or automated crawler programs. In a less preferred mode, manual collection, user research, and/or review of paper or electronic documents or other kind of data may be undertaken.

Following the initial collection of target user and/or customer background data, the assembled profile data is aggregated and compiled by the server 14 (step 50). Most preferably, the collected data is filtered and classified against a library of known cyber attack strategies and techniques stored in the memory 18 to identify areas of commonality which could identify target-user specific baited protocols which have an increased and/or greatest vulnerability to social engineering based cyber attacks. The assembled data is compiled and weighted to provide an estimate of target user and/or organization vulnerability as a whole, to the risk and/or susceptibility to third party social engineering phishing, data collection and/or other cyber attack schemes. As will be described, the results and analyses of one or more previously executed simulated social engineering-based cyber attacks may also be optionally aggregated with information collected as background data.

In one non-limiting mode of operation, the system algorithm produces feature vector or matrix X, which is representative of the state sₜ of data at time t. The host server 14 receives as input, unstructured data of the target user 26 and stored programming converts it into the vector (or matrix) using a combination of techniques which may include but not limited to mapping, graph embedding, clustering and regression techniques.

Feature vector X could in some instances, adopt the form of a d×m matrix A={aᵢⱼ}. The latter, for example, could be more suitable for an image or the adjacency/attribute matrix of a graph representing a network.

Examples of the target user's 26 unstructured data may, for example, include social and professional network data; represented as graphs, collections of documents with personal data, images, numerical and nominal data about the individual or a group of individuals. The system algorithm may be fed other forms of data when producing feature vector X, including context data.

The aggregated data and information from Step 50 is thereafter fed into a training predictor (TP) module or algorithm (step 60) stored in the memory 18 of the host server 14, and correlated with established cyber attack playbook templates stored in memory 18. As will be described, the playbook templates preferably include a number pre-stored cyber attack strategies and subroutines which incorporate bait protocols selected to illicit a user response either revealing secure and/or sensitive information, or otherwise which is likely to open the workstation 20 to malware.

Preferably, compiled data is correlated to the particular playbook templates by the processor 16 to identify, and most preferably provide a ranked weighting, of bait profiles which may have a greatest likelihood of receiving a response when presented to the target user 26 associated with the collected profile data. The aggregated data and information are used to generate and output to each user workstation 20a, 20b, 20c a simulated cyber attack.

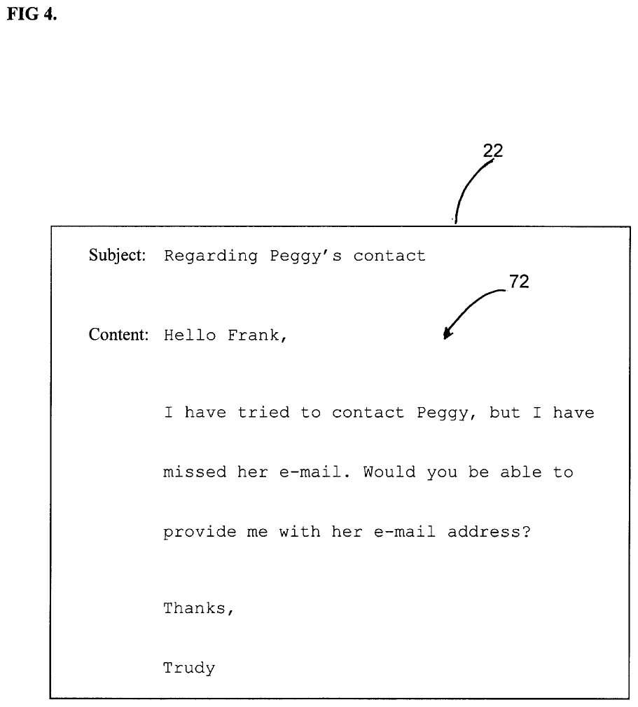

The simulated cyber attack generated in step 70 may be in the form of a generated phishing simulation which includes one or more identified target user-focused bait protocols which are selected based on their ranking. For example, in the exemplary embodiment described the TP algorithm preferably generates the phishing simulation 72 shown in FIG. 4 with a bait protocol. The bait protocol is chosen by predicting the best action to be performed, that is, by predicting a most-likely to succeed social-engineered cyber attack, based on the information obtained in Step 50. In this way, the TP algorithm may be used to develop a simulated attack that is customized to each target user 26.

The TP algorithm preferably is utilized to predict a best action, whereby for a proposed simulated cyber attack, the bait protocol which is identified as having a higher or highest chance of response is chosen from a set of prestored attack plans stored in the server memory 18:

a={a₁, a₂, a₃, . . . , aₘ}

It is to be appreciated that different types of cyber attacks may be chosen in step 70 including without limitation phishing, pharming, pretexting, baiting, tailgating, vishing, smishing, ransomware, fake software, and other types of socially engineering based attacks. Based on the current state sₜ of the reinforcement learning algorithm and compiled profile data dataset, one or more best bait protocol aₜ are chosen and customized for each target user 26 different available attack templates.

Each simulated cyber attack template may further be associated with a theme, and any such theme(s) may be selected by the TP algorithm. A template could, for example, contain “parts” or fillable “fields” to be completed or filled by the TP. Each fillable “part” or “field” combined with the type of attack will correspond to an action in the set a={a₁, a₂, a₃, . . . , aₘ}.

FIG. 4 shows the sample displayed phishing e-mail 72 as received and displayed on the monitor 22 of the target user 26 in accordance with an exemplary embodiment, where a scheme chosen from the simulated cyber attack is prepared as an interactive e-mail. In generating the phishing e-mail 72, the host server 14 accesses a scripted cyber attack template stored in memory 18. The scripted template may for example, may have server compliable data fields as follows:
Subject: Regarding [Peggy]'s contact
Greeting: Hello [Frank],
Introduction: I have tried to contact [Peggy], but I have missed [her] e-mail.
Request: Would you be able to provide me with [her] [e-mail address]?
Closing: Thanks,
Signature: Trudy
Subject: Regarding Peggy's contact
Content: Hello Frank,
   I have tried to contact Peggy, but I have missed her e-mail.
   Would you be able to provide me with her e-mail address?
   Thanks,
   Trudy

In the foregoing example, the type of attack together with each fillable part of the displayed e-mail 72 shown, may consist of an action in the set a, as follows:
a₁=e-mail
a₂=Regarding [person]'s contact
a₃=Peggy
a₄=Frank
a₅=her
a₆=e-mail address
a₇=Thanks
a₈=Trudy
etc.
   Different arrangements and categorizations of the fillable “parts” may be used, as will be appreciated by those skilled in the art. For instance, the entire line of the request in the particular example could have included an action as well (e.g. “I have tried to contact [name]”, where [name] per se may be another action in the set (i.e. Peggy)).

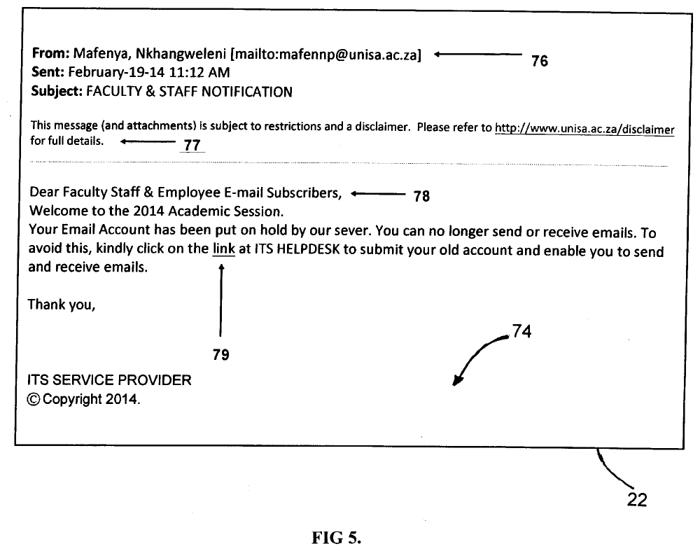

An alternative example of a displayed e-mail 74 simulated cyber phishing attack which includes multiple fillable fields and which is displayed on the target user's workstation monitor 22 is shown in FIG. 5. The displayed e-mail 74 shown in FIG. 5 is identified as having the following separate actions a: external e-mail address 76, disclaimer from external site 77, generic non-personalized greeting 78, and a link pointing to a non-Sheridan site 79.

Following generation, the server 14 is used to execute the simulated cyber attack generated by the server TP algorithm (Step 70), and the simulated e-mail 72, 74 is electronically communicated to a selected remote target user workstation 20 via the cloud 30. In one possible mode, the server 14 may be provided as a dedicated attack engine (AEG) which operates to both generate and send simulated cyber attacks, as well as harvest, compile and assess collected data from the target user 26 generated by any level of reply. Although not essential, the host server 14 preferably forwards simulated cyber attacks to each of the workstations 20a, 20b, 20c of multiple target users 26. The concurrent dissemination of the same simulated cyber attack to multiple target users 26 advantageously may allow for a concurrent, customer-wide snapshot of existing cyber security vulnerabilities, with lessened concern that the actions of one target user could influence another. In another mode, however, training may be provided on a user-by-user basis, individually, with individual custom bait protocols, soliciting a response or reply.

The TP algorithm is most preferably is selected to utilize AI techniques, machine learning and reinforcement learning to analyze subsequent response data collected from target user 26 responses and re-generate one or more further simulated cyber attacks, depending on target-user outcomes. So as to safeguard the target user(s) and organization's systems, all attacks carried out by the server 14 as part of the SETA tool are unweaponized, and/or payloads delivered by means of the server 14 AEG's attack features are inactive, and thus cannot harm the workstations 20.

FIG. 4 illustrates the example e-mail 72 which is displayed on the computer monitor 22 of the target user 26, and which solicits the target user's 26 positive response action. The positive response action may, for example, include a direct response for confidential and/or secured information, the downloading of malware by accessing a misidentified link, or alternatively provide a link to one or more further webpages. The user results of the executed attack(s) are collected, recorded and analyzed in the server 14 at Step 80.

In an optional mode, the target user 26 results and analyses of the simulated cyber attack(s) are fed back into the processor memory 18. The target user 26 responses and data are then used to update the profile data of the SETA tool, with added data aggregated and analyzed according to step 50. After further correlation and compilation to identify next optimal bait protocols (step 60), a next simulated cyber attack (step 70) is then generated. The TP algorithm thus benefits from the previous simulated attack results, to generate a next or future attack(s) using updated information. In this way, embodiments of the invention may advantageously provide a method that repeatedly engages the particular target user 26 with varied and/or updated simulated cyber attacks which are response dependent or influenced.

The trained predictor (TP) algorithm which correlates compiled data and generates simulated attacks may be viewed as forming part of the SETA training system as a whole. At the time of initializing the system at time 0, the initially compiled user profile data and training dataset is input into the algorithm. In time, however, the TP algorithm is updated and re-trained at the time profile data or training dataset is updated by user responses.

The main role of the TP algorithm is to predict the most likely successful bait protocol to be used as part of the reinforcement learning module. The trained predictor algorithm preferably performs this prediction by maximizing the discounted future reward Rₜ according to Equation (1) described hereafter.

To best perform its prediction, the trained predictor algorithm has as inputs, preferably at least the state sₜ of the learning programme at time t in the form of a feature vector X, and a set of possible actions or baits or bait protocols a={a₁, a₂, a₃, . . . , aₘ} that may be adopted. Optional additional inputs may also include a pre-trained predictor and current training dataset. Both the profile data and context data may be used to produce the feature vector X, as follows:

X=[x₁, x₂, x₃, . . . , a_{dd}]^{t}

where d is the dimension of the vector space.

As will be described, in one embodiment a reinforced learning algorithm or module operates to maximize a discounted future reward (or return) of executing generated attack(s). At time t, the discounted future reward Rₜ may be calculated as follows:

Rₜ=Σᵢ₌ₜⁿγⁱrᵢ=γ^{t}rₜ+γ^{t+1}rₜ₊₁+ . . . +γⁿrₜ₊ₙ (1)

where rₜ is the reward obtained from the target user's response at time t; and γ is the discount factor, which is a number between 0 and 1 that can be calculated as a random value (e.g., 0.7) or learned via the RL iterative process. The future reward may be determined by counting or scoring the number of simulated cyber attacks, which are successful and where the target user 26 is “tricked” by the by the bait protocol into a response. An individual target user score may further be determined based on the type of attack aₜ which is sent to the target user 26, and the responses obtained from a particular type of attack.

For example, a particular score may be given based on the type of cyber attack carried out, wherein a same score is given for all different types of attacks. In one possible mode, one classification could be phishing, which would receive a similar score to pharming, tailgating, vishing, etc. Another classification receiving a score could be based on the means or tool used in carrying out the attack, for example, if conveyed by social media platforms such as a Twitter™ post, Facebook™ post or message, e-mail, ResearchGate™ message, Linkedin™ message, Linkedin™ post or message, etc.

In this way, a particular simulated cyber attack could result in one or more scores, depending on how potentially damaging the security lapse. If the simulated attack is an e-mail sent to the target 26 user with a URL link, one score could be assigned if the target user clicks on that link. If the link provided asks the target user 26 to enter a PIN, password or personal/institutional data, a further score may be added to the reward/penalty if the relevant PIN, password or personal/institutional data is provided.

The reward rₜ at time t may thus be obtained by calculating the sum of scores for any items involved in the target user's behavior: (i) type of attack, (ii) target user's reaction(s) to the attack. For example, rₜ may be calculated as:

rₜ=c₁+c₂+c₃+ . . . cₚ

where p is the number of items to be scored at time t, and each of c₁, c₂, c₃, etc. may, for example, represent the following:
c₁=score for the type of playbook used (i.e. e-mail)
c₂=score for the target clicking on a URL link
c₃=score for the target entering personal data
c₄=score for any further actions executed by the Target
etc.

The trained predictor algorithm may be programmed to use either model-free or model-based learning such as Q-learning or policy-based mode. Where the TP algorithm employs model-based learning, the following two models can be used, depending upon the phase of operation of the learning programme, the target user and the bait protocol being generated:
Q-Learning (also known as “Value Learning”)
Policy Learning.

Value learning may be used when the set of actions a={a₁, a₂, a₃, . . . , aₘ} is small and discrete, whereas Policy Learning is more suitable when the set of actions a is extremely large. In the case of social engineered based cyber attacks, the number of actions a can range from small to large, depending on the number of possible types of attacks, the number of “fillable” fields per type of attack and the number of possible ways in which these fields can be filled in. The type and size of an organization can also play a role in determining the number of actions included in a set.

Value Learning is a type of model-free learning that may be used by the TP in maximizing the discounted future reward Rₜ defined by Equation (1) above. The aim of Value Learning is to find a function Q(s, a) which maximizes the total expected future reward Rₜ at time t, when the Agent is at state sₜ, namely:

Q(sₜ, aₜ)=E[Rₜ|sₜ, aₜ] (2)

In order to optimize Equation (2), a policy π(s) may be derived and used to infer the best action aₜ. Any policy that estimates the best value of Q* can be used to approximate the maximum value as follows:

$${π}^{*} ( s ) = {argmax}_{a} Q ( s , a ) \qquad ( 3 )$$

The foregoing function can be maximized via different approaches. The Bellman equation is one example of a function that optimizes the policy, thereby allowing the Agent to move to state sₜ₊₁, as follows:

$${Q}_{t + 1} ( {s}_{t} , {a}_{t} ) = {Q}_{t} ( {s}_{t} , {a}_{t} ) + α ( {R}_{t + 1} + γ {max}_{a} {Q}_{t} ( {s}_{t + 1} , a ) - {Q}_{t} ( {s}_{t} , {a}_{t} ) ) \qquad ( 4 )$$

where α is the learning factor.

In Value Learning, maximizing Q as in Equation (2) or (3) may be done by means of dynamic programming to solve the Bellman equation or using other techniques as described in R. Sutton and A. Barton, “Reinforcement Learning: An Introduction”, Second Edition, MIT Press, 2018.

In the model free other machine learning and optimization approaches as well, including but not limited to: Bayesian learning approaches, nearest neighbor, support vector machines, random forest, neural networks, dynamic programming, and stochastic optimization algorithms such as evolutionary computation, simulated annealing or ant-colony optimization. More details on how these methods can be implemented are discussed in (i) R. Duda et al., “Pattern Classification”, Wiley, 2000; (ii) S. Abe, “Support Vector Machines for Pattern Classification”, Springer, 2010; (iii) R. Genuer, R. Poggi, “Random Forests with R”, Springer, 2020; (iv) E. Chong, S. Zak, “An Introduction to Optimization, 4th Edition”, Wiley, 2013. Following recent trends in machine and deep learning, for example, a deep Q-neural network (Q-NN) could be used. In such a case, a gradient-based policy optimization algorithm can be applied to train a neural network which, in turn, is used to optimize the function (s). The neural network would adopt a specific architecture depending on the data available for the Target at state sₜ (e.g. images, text, documents, audio, and/or numerical data). More details on how a Q-NN may be derived are discussed in: (i) L. Graesser, W. L. Keng, “Foundations of Deep Reinforcement Learning: Theory and Practice in Python”, Wiley, 2019; and (ii) R. Sutton and A. Barton, “Reinforcement Learning: An Introduction”, Second Edition, MIT Press, 2018, the entirely of each of which is incorporated herein by reference.

The Value Learning mode may make use of the “Exploration vs. Exploitation” principle (or soft policy approach), which aims at combining a greedy approach of identifying the best action aₜ time t (exploitation) and some probability (exploration). The latter involves choosing an action randomly with some probability ∈, or finding the best (optimal) action with probability 1−∈.

Policy Learning can be implemented as a model-free learning model that may be used by the TP in maximizing the discounted future reward Rₜ defined by Equation (1) above.

In Policy Learning, there is no explicit form for the function Q, and a set of actions a is not needed as a parameter. Rather, the state sₜ of the Agent is the only parameter required in order to find a policy (s) that maximizes the reward Rₜ. This can be done, for example, by sampling the actions a={a₁, a₂, a₃, . . . , aₘ} and calculating the probability of each action based on the current state and future reward. A bait protocol aₜ is chosen by randomly choosing an action aᵢ with probability P(aᵢ). Actions or bait protocols with higher probability will thus have a higher chance of being chosen. More formally:

Find(s) (5)

Sample a˜(s) (6)

Once an attack is chosen and generated, it may be sent to the target user 26, who will then react to it with responses which are returned to the host server 14 for processing. A reward is calculated, and based on that reward, the probability of a particular bait protocol aₜ as being assessed as suitable may be increased or decreased. The probabilities of the other actions are also updated accordingly and adjusted to satisfy the law of total probabilities, given below:

Σᵢ₌₁^{m}P(aᵢ)=1 (7)

More details about this process can be found in R. Sutton and A. Barton, “Reinforcement Learning: An Introduction”, Second Edition, MIT Press, 2018.

Using the example of FIG. 4, if there are three possible attacks that can be generated when the SETA learning programme is in state sₜ, namely a₁, a₂ and a₃. These actions could include by way of example the generation of an e-mail using the following sample bait protocols:
a₁=“Dear Frank,
   I have prepared the document we discussed. Click here for the latest version.
   Regards,”
a₂=“Dear Frank,
   Thank you for your interest in our latest security products. We can offer three different packages. Click here for more details. Yours,”
a₃=“Dear Frank,
   Our partner Ingenuity Software has given us back the quote. The document can be seen here. Talk to you later.”

In the example above, “Frank” is the target user 26 and manager of the Purchasing Office. The word “here” in underline contains a phishing link that asks the target user 26 to provide information about himself and/or the company. Based on “Frank's” reaction to the link, and how much information ,the target user provides in response to the simulated cyber attack, a reward is calculated.

Assume, for example, that P(a₁)=0.8, P(a₂)=0.1 and P(a₃)=0.1. If a₁ is chosen as the attack to be sent to the target user, the target user will react to the attack a₁. If he or she elects not to click on the phishing link, then the probability of a₁ will be decreased to, say, P(a₁)=0.6, and the other two increased to P(a₂)=P(a₃)=0.2. The SETA learning programme would thereafter move on to state sₜ₊₁, and a next simulated cyber attack would be prepared.

Most preferably, the system 10 operates whereby the profile data in the training dataset is maintained up to date, and the SETA tool operates to provide re-training to target users 26 as needed, throughout various iterations of the system 10.

The system 10 may be adapted to receive two different types of inputs: (i) a reward and/or penalty at each simulated cyber attack or attack step, in the form of responses from the target user 26, and (ii) the entire playbook which results from a sequence of simulated cyber attacks on an individual target user 26.

The system 10 is preferably configured to perform two different, but related tasks. Firstly, it updates the training dataset and profile data based on responses and successfully received playbooks from the target user 26, after a sequence of simulated cyber attacks has concluded. Secondly, it updates the training predictor algorithm based on individual responses received from the target user 26 during a cyber attack, and/or from the results of entire playbook that results from a sequence of simulated attacks.

The method thus iteratively exposes target users 26 to socially engineered cyber attacks in a safe environment, and helps grow their understanding of such attacks while simultaneously training them to recognize, and thus respond to, social engineering threats.

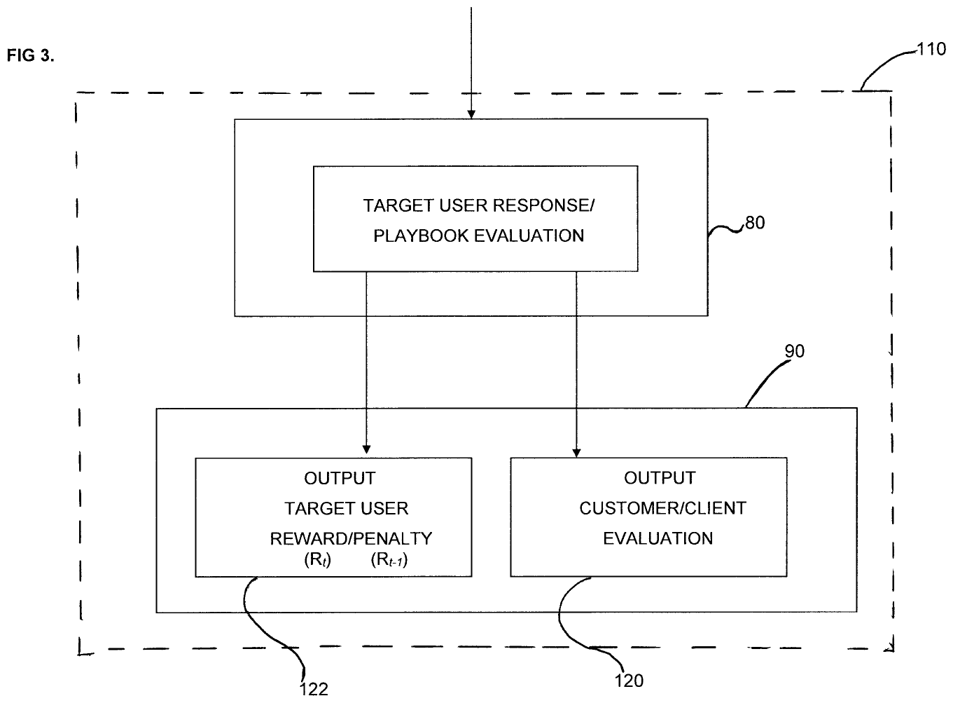

Further, after harvesting and analysis of target user data in step 80, target user or customer security mitigation and awareness policies may output to the user 26 and/or customer (step 90). As well, policies may be updated to reflect any experience or knowledge that was gained in carrying out the generated attack(s). In addition, following the execution of the simulated cyber attacks, the response analysis and user output evaluation may be provided in conjunction with optional gamification module (Step 110 depicted in FIG. 3). Depending on the target user's 26 exhibited vulnerability to the simulated cyber attacks, the target user 26 may be subject to the gain or loss of virtual or personal rewards based on their response awareness and performance. The gamification may be provided as part of a company wide game scheme designed to illicit greater engagement and participation in the training method. In another mode, individual target users may be incentivized to compete for virtual rewards, coupons or benefits, depending on their exhibited knowledge and responses to the simulated cyber attacks.

In a preferred embodiment the system 10 may be set to provide automated learning to the target users 26, as for example on a timed sequence, calendar basis, or at random epochs. In the automated learning routine, the system 10 is initialized at time 0 and/or with the algorithm generated simulated cyber attack at state so. Each time the algorithm engages or baits the target user 26, time t increases and the algorithm receives a target user response which is used to update the state sₜ of the system for the next iterative step.

At the outset, as shown with reference to FIG. 2, the system 10 is initialized based on initial information and training dataset gathered with respect to the target user 26, and which is aggregated (step 50) to forms part of a first baited protocol for state Sₒ depicted in FIG. 2. As was described above, information gathered may, for example, include data regarding the target user and/or client social media profiles, policies and objectives. The aggregated data is used in generating a simulated cyber attack by the incorporation of threat modeling information, selected cyber attack playbook templates or scripts, which incorporate a bait protocol and possible attack surface analyses.

Part of the initial training dataset used in the initial simulated cyber attack at state Sₒ may be obtained after performing several handcrafted attacks on different targets, and recording their actions and responses. In this way, an initial compiled training dataset used in formulating simulated cyber attacks may include manually recorded entries of initial test attacks.

In subsequent iterations of the system, the user responses received by the server 14 may also be used to provide tabulated system outputs 120, 122, 124. These may include one or more of final scores, results of subsequent simulated cyber attacks, virtual rewards and/or penalties; and/or logs of individual target user responses and/or actions, executed attack(s), including sequence of steps taken and, at each step, the actual playbook utilized in executing the attack(s) and the target user's responses.

FIG. 2 shows best the operation of the system 10 wherein a reinforcement learning (RL) module or algorithm provided. The RL module preferably is provided as a collection of algorithms which are stored in program code in the server memory 18. In a most preferred non-limiting embodiment, the RL module utilizes suitable algorithms which are operable to accomplish tasks including the execution of one or successive simulated cyber attacks, the analysis and predicting of updated bait protocols (aₜ), the generation of target user scripts and response prompts; the implantation of gamification rewards or penalties for one or more users; and the updating of datasets.

Although not essential, most preferably the system 10 operates to provide for gamified learning. In one non-limiting version, the target user 26 may be provided with virtual rewards or coupons for successfully identifying social engineering based cyber attacks. As well, the system may include penalty or competition component, which rewards or penalize the target user 26 based on direct response or responses in comparison to peers: In this embodiment of the invention, the RL module may also tabulate rewards and/or penalties, based on the target users' 26 performance.

In the exemplary mode, at time t, the server 10 is in state sₜ and an initial simulated cyber attack is generated with a selected bait protocol and electronically communicated to the target user's workstation 20. In preparing the simulated cyber attack, the training predictor (TP) algorithm preferably generates the bait protocol aₜ for the specific target user 26 at time t, using machine learning techniques, to select the protocol weighted as having highest or higher likelihood of response or expected to collect the highest discounted reward. This is done on the basis of the compiled training profile data, which aims at maximizing the success rate of the attack, and the partial training dataset entries that correspond to the target user 26.

If the target user 26 reacts to the baited protocol aₜ by sending a response to the server 14, the response is stored in memory 18. Depending on the response nature, and whether sensitive or secure, information received is recorded and processed as a reward (rₜ) or penalty (rₜ₋₁). The reward rₜ may further be sent along with a playbook of the simulated cyber attack to update the training dataset for the target user 26. Both the response of the target user 26 are sent to the gamification module 110 which provides a reward output and/or penalizes the target user 26. Preferably the system 10 further creates any necessary output reports or actions 120, 122, 124 for the target user 26 or organization to mitigate the potential for real attacks. The system may then move to a next state sₜ₊₁, and a next simulated cyber attack with updated baited protocols is generated. The RL module iterates in this fashion until the TP algorithm predicts a “No Bait” action, at which point, the loop terminates and the playbook of the SETA tool interactions with the target user again sent to the update and gamification modules as described above.

Gamification may, in other preferred embodiments, include a set of levels, goals, themes, and/or dynamic scoring designed to increase target user engagement. The goals and challenges may be designed to be configurable and managed through a set of semantic restrictions, including but not limited to property restrictions, existential restrictions, or cardinality restrictions.

The TP module preferably operates using machine learning, and which operates in canonical vector spaces. Most preferably, the system 16 algorithms are selected so as to also be capable of processing such data, and collect unstructured data which is integrated to represent as a single feature vector X=[x₁, x₂, x₃, . . . , x_{d}]^{t}, where d is the dimension of the vector space. Different forms of data however may also be represented as vectors using specific mathematical models and machine learning approaches. For example, professional and social network data is typically represented as weighted, attributed graphs G=(V, E, W), where V are the attributes (i.e. individuals), E are the edges (i.e. connections between individuals), and W are the weights (i.e. attributes that quantify the interactions amongst individuals within or outside the organization). Graph embedding techniques that perform node or edge representation as vectors may be used in this regard, such as Node2Vec or random walks. Suitable graph embedding techniques, are for example described in: W. Hamilton et al., “Representation Learning on Graphs: Methods and Applications”, Cornell University, 2018, the entirety of which is incorporated herein by reference.

Policies, individuals' profiles, possible attack scenarios and/or scripts, news, and other types of documents are preferably represented as text. Techniques for natural language and text processing are preferably used to transform such unstructured data into vectors, including Doc2Vec, gram models, Word2Vec, recurrent neural networks and others.

Image data is preferably transformed onto vectors via object recognition, segmentation, and convolutional neural networks, amongst others. Such transformation techniques are for example described in: (i) C. Aggarwal, “Neural Networks and Deep Learning”, Springer, 2018; (ii) Mikolov et al., “Distributed Representations of Words and Phrases and their Compositionality”, NIPS, 2013; or (iii) S. Skansi, “Introduction to Deep Learning”, Springer, 2018, the disclosures of each of which are incorporated herein by reference in their entirety.

Numerical and nominal data can be represented “as is” or normalized and pre-processed to avoid any bias in particular features, and also reduced in dimension, as for example described in: T. Hastie et al., “The Elements of Statistical Learning”, Second Edition, Springer, 2008, the disclosure of which is incorporated herein by reference in its entirety.

A very large number of numerical and/or nominal features usually pose a problem called the “curse of dimensionality” in machine and representation learning. For this purpose, dimensionality reduction techniques are used to represent data of prohibitively-high dimensions (typically, on the order of thousands or millions) onto more manageable data of lower dimensions. A number of techniques are used in this regard, including but not limited to multidimensional scaling, self-organizing maps, component analysis, matrix factorization, autoencoders, and manifolds, amongst others. Such transformation techniques are believed in one or more of: (i) Hout M. C., Papesh M. H., Goldinger S. D., “Multidimensional scaling”, Wiley Interdiscip Rev Cogn Sci, 2013, 4(1):93-103; (ii) N. Fatima, L. Rueda, “iSOM-GSN, An Integrative Approach for Transforming Multi-omic Data into Gene Similarity Networks via Self-organizing Maps”, Bioinformatics, btaa500, 2020; (iii) T. Hastie et al., “The Elements of Statistical Learning”, Second Edition, Springer, 2008; (iv) Y. Wang et al., “Nonnegative Matrix Factorization: A Comprehensive Review”, IEEE TKDE, 25:6, 2013; (v) C. Aggarwal, “Neural Networks and Deep Learning”, Springer, 2018; and (vi) S. Skansi, “Introduction to Deep Learning”, Springer, 2018, the disclosures of each of which are incorporated herein by reference in their entirety.

Integrative approaches may be used to gather all of the foregoing data and “embed” them into a single feature vector (or matrix) X, which is needed as input for the TP algorithm.

The system 10 may also be afforded a second task in the identification of potential target users 26 prior to the initialization of the SETA training system at time 0 (tₒ). In particular, the SETA tool may be programmed to employ a number of different techniques for identifying patterns or classes in which data shares in common features. In this way, the SETA tool may be adapted to group particular individuals, groups of individuals, roles or profiles into potential target groups.

Examples of possible machine learning techniques employed to detect potential target users may, for example, include: classification, clustering, regression, identifying hubs in graphs, finding keywords or motifs, or classifying particular individuals. Such techniques could include, but are not limited to: the family of deep neural networks; support vector machines; decision trees; random forests and neural random forests; Bayesian classification; k-Means family of techniques, including fuzzy and expectation maximization; graph clustering techniques such as k-centers, community detection and densest overlapping subgraphs (see for example (i) C. Aggarwal, “Neural Networks and Deep Learning”, Springer, 2018; (ii) M. Alazab and M. Tang, “Deep Learning Applications for Cyber Security”, Springer, 2019; (iii) S. Skansi, “Introduction to Deep Learning”, Springer, 2018; (iv) Awad M., Khanna R., “Support Vector Machines for Classification”, Efficient Learning Machines, Apress, Berkeley, Calif., 2015; (v) Biau, G., Scornet, E. & Welbl, J., “Neural Random Forests”, Sankhya A 81, 347-386, 2019; (vi) Martínez Torres, J., Iglesias Comesaña, C. and García-Nieto, P. J., “Review: machine learning techniques applied to cybersecurity”, Int. J. Mach. Learn. & Cyber, 10, 2823-2836, 2019; (vii) Panda S., Sahu S., Jena P., Chattopadhyay S., “Comparing Fuzzy-C Means and K-Means Clustering Techniques: A Comprehensive Study”, Advances in Computer Science, Engineering & Applications, Advances in Intelligent and Soft Computing, vol 166, Springer, Berlin, Heidelberg, 2012; (viii) Galbrun, E., Gionis, A. & Tatti, N., “Top-k overlapping densest subgraphs”, Data Min Knowl Disc, 30, 1134-1165, 2016; and/or (ix) J. Yang, J. McAuley and J. Leskovec, “Community Detection in Networks with Node Attributes”, IEEE 13th International Conference on Data Mining, Dallas, Tex., 2013, pp. 1151-1156, doi: 10.1109/ICDM.2013.167, the disclosures of each of which are hereby incorporated herein in their entirety.

Embodiments of the invention may include a gamification model that supports both passive and active modes of simulated cyber attacks. In the passive mode, an attack script or playbook is executed without the target users 20 knowing that they are participating or taking part in ongoing cyber security training. In the active mode, target user's 26 know they are participating in a training program, and understand they are challenging an AI engine that will act as their opponent. Gamification models that operate in active mode, in particular, may use points or other reward systems to better engage target users 26 and increase user participation. Passive attack modes focus on: evaluating the organization's cyber security posture, estimating social engineering attack surfaces, measuring the organization, and identifying potential weaknesses in the organization's security policies and strategies. Outputs from a passive mode of the invention may be used, for example, to help create a customized anti-social engineering training program based on the customer organization's needs.

In another possible embodiment, the system 10 may operate to execute one or more simulated cyber attacks based on the SETA training program, and attack playbooks may be categorized into a number of different levels based on the complexity and severity of the simulated attack. Each attack playbook may also be given a theme and narrative to help keep learners engaged and motivated. For instance, one playbook theme in the healthcare sector could be a social engineering attack that targets patients' medical records.

Each SETA training plan or program can be given one or more goals. A possible goal could, for example, be to improve the attack detection rate, and/or to evaluate mitigation and recovery procedures. Each goal may be divided into a set of achievable sub-goals with a predefined weight/value. Following execution of any simulated cyber attack, the target users' 26 responses or countersteps may be recorded and scored according to these goals or sub-goals using a set of metrics.

The goals and sub-goals may share a predefined dependency structure which describes their prerequisites and post-conditions. The system 10 optionally may use this set of prerequisites and post-conditions to describe the goals and how they should be achieved. For example, a prerequisite to detect a phishing attempt for personal information may be to recognize the threat artifact (e.g., e-mail, SMS message, instant message, etc.) and identify social-engineering tactics (e.g. friendliness, impersonation, influence, etc.).

When one or more prerequisites are satisfied, the learner/target user 26 is awarded point rewards and at the same time, the post-condition(s) is triggered. In the case of a phishing attempt, for example, the post-condition may be a reported phishing attempt. Furthermore, the post-condition of a reported phishing attempt itself may be a prerequisite for detecting a phishing campaign. When the number of target users 26 who have reported a phishing attempt reaches a predefined threshold, a prerequisite for detecting a phishing campaign may thus be achieved. A second prerequisite for detecting a phishing campaign may also be achieved when the IT or cyber security team at the customer organization sends an alarm to all individuals who might be affected by the phishing campaign. Gamification may thus be used to score an individual's achievement (i.e. report a phishing attempt) and to score a group achievement (i.e. multiple reportings of phishing attempts).

Other gamification models may make use of goals and/or sub-goals that are time-based or that have time constraints. By way of example, a simulated cyber attack based on a ransomware playbook attack could measure the organization's mitigation and recovery plan by measuring the time it takes to isolate the compromised machines and disconnect them from the network. Advanced playbooks at a higher level in the gamification model may contain more sophisticated challenges. For instance, in a botnet attack playbook, one of the goals may be to identify patient zero (i.e. first machine to be compromised).

Dynamic target user scoring may also employ such scoring may be affected by how and/or by who the goals are achieved. For example, time-based goals may have time-based scoring. Goals with cardinality restrictions, like detecting a phishing campaign, may make use of proportional scoring based on the number of individuals who report phishing attempts. The scoring may also be level-based, such that when a target user 26 with an expert or advanced level completes a goal at a lower level, he/she receives only the minimum score afforded by this goal. Conversely, where an expert or advanced user fails at a lower level, he/she may lose points, and so on.

In active training mode, target users 26 themselves may be allowed to track their progress and points. The points system could thus be used by users to gain an incentive within the training program (e.g., use points to get hints or help, use points to buy more time for time-based goals, etc.). Furthermore, the organization could use the points system to award users other types of incentive (e.g., physical or monetary incentives or prizes).

A target user 26 engaged in the presently described embodiment may be rewarded on the basis of the RL module reward scheme, as formalized by Equation (1) above: At the end of a simulated cyber attack, the sequence of rewards may be calculated, obtaining a total discounted reward Rₜ. Rewarding the target user 26, however, is in contradiction with rewarding the RL algorithm, since the two have opposite goals: (i) the object of the SETA tool RL algorithm or module seeks to succeed in the attack, (i.e., trick the target user with the attack); while (ii) the target user wishes to outsmart the attack. Taking these two counteracting forces into consideration, a further possible scheme to generate “rewards” may be to reward the target user using −Rₜ, as a basis for a scoring mechanism.

Embodiments of the invention may be implemented by way of various computer systems, and are not dependent on any specific type of hardware, network or other physical components. Rather, the embodiments of the invention may be implemented by way of any number or combination of existing computer platforms.

Although FIG. 4 depicts a social engineering attack in the form of an e-mail to be sent to the target user 26; the invention is not so limited. Social engineering based cyber attacks generated and executed by the SETA tool using the system 10 may take many different forms, including but not limited to any of the types of social engineering based cyber attacks discussed previously. By way of example, malicious links included in a phishing e-mail or by social media, professional or research networks could deliver Ransomware attacks; or computer bots leveraging AI could generate vishing calls or messages and record target responses.

In use of the system 10, each target user may furthermore be subjected to simulated social engineering based cyber attacks which are presented in different forms iteratively and/or at different times after selected or random interruptions by means of the reinforcement learning (RL) algorithm stored as programme code in the server memory 18.

Although FIGS. 4 and 5 illustrate graphically an exemplary actor or machine generated algorithm bait script which as displayed on the workstation monitor 22 as one of a successive simulated cyber attacks, the invention is not so limited. Other suitable bait scripts selected for engaging the interaction of the target user 26 by delivering to him/her a specifically generated action or bait protocol aₜ may also be used.

We claim:

1. A system for administering social engineering security training, the system comprising:
a reinforcement learning (RL) module, the RL module comprising a trained predictor and an agent that interacts with a target;
wherein the RL module receives as input a training dataset, the training dataset comprising information regarding the target;
the trained predictor generates a bait for the target based on the input training dataset;
the agent delivers the generated bait as an attack on the target; and
based on the responses received from the target, the RL module outputs a playbook of the attack, the playbook comprising the target's response to the bait.

2. The system according to claim 1, further comprising an update module that updates the trained predictor and the training dataset based on at least one previously outputted said playbook and the responses from the target.

3. The system according to claim 2, wherein the updated trained predictor generates the bait for the target based on the updated training dataset.

4. The system according to claim 1, wherein the agent interacts iteratively over time with the target.

5. The system according to claim 3, wherein the agent interacts iteratively over time with the target.

6. The system according to claim 1, further comprising a gamification module that rewards or penalizes the target based on the target's response to the bait.

7. The system according to claim 5, further comprising a gamification module that rewards or penalizes the target based on the target's response to the bait.

8. A method for administering social engineering security training, the method comprising steps of:
a) harvesting data about a target;
b) mining relevant security knowledge from the harvested data;
c) estimating a potential social engineering threat to the target based on the mined security knowledge;
d) analyzing the potential social engineering threat and generating a customized social engineering attack based on the analysis;
e) executing the customized social engineering attack against the target; and
f) analyzing the target's response to the customized social engineering attack.

9. The method according to claim 8, wherein the data harvested about the target comprises results and analyses of at least one previously executed said social engineering attack on the target.

10. The method according to claim 8, wherein the customized social engineering attack executed against the target is un-weaponized.

11. The method according to claim 8, further comprising a gamification step wherein the target is penalized or rewarded based on the target's response to the customized social engineering attack.

12. The method according to claim 9, further comprising a gamification step wherein the target is penalized or rewarded based on the target's response to the customized social engineering attack.

13. The method according to claim 8, further comprising:
g) recommending at least one social engineering countermeasure based on the target's response to the customized social engineering attack.

14. The method according to claim 10, further comprising:
g) recommending at least one social engineering countermeasure based on the target's response to the customized social engineering attack.

15. The method according to claim 9, further comprising a gamification step wherein the target is penalized or rewarded based on the target's response to the customized social engineering attack.

16. A non-transitionary machine readable medium storing a program for administering remote social engineering security training on a remote target computer, the program comprising sets of instructions for:
a) harvesting data about a user of the target computer;
b) mining relevant security knowledge from the harvested data;
c) evaluating a potential social engineering threat to the user target based on the mined security knowledge;
d) generating a simulated social engineering cyber attack customized to said user based on the analysis;
e) executing the simulated social engineering attack against the target computer; and
f) analyzing the user's response received from the target computer to the simulated social engineering cyber attack.

17. The machine readable medium as claimed in claim 16, wherein the program includes instructions for harvesting data about the user of the target computer comprises results and analyses of at least one previously executed said social engineering attack on the target computer.

18. The machine readable medium as claimed in claim 17, wherein the program includes instructions for generating a customized simulated social engineering attack which is un-weaponized.

19. The machine readable medium as claimed in claim 17, further wherein the program includes instructions for outputting to the target computer, a gamification response; wherein the user is penalized and/or rewarded based on responses received from the target computer in response to the customized simulated social engineering cyber attack.

20. The machine readable medium as claimed in claim 18, further wherein the program includes instructions for outputting to the target computer, a gamification response; wherein the user is penalized and/or rewarded based on responses received from the target computer in response to the customized simulated social engineering cyber attack.
